(19) United States
(12) Patent Application Publication
(10) Pub. No.: US 2015/0120949 A1
(43) Pub. Date: Apr. 30, 2015

(54) INFORMATION PROCESSING APPARATUS, INFORMATION PROCESSING METHOD AND PROGRAM

(71) Applicant: Sony Corporation, Tokyo (JP)

(72) Inventor: Koichi Ogasawara, Tokyo (JP)

(73) Assignee: Sony Corporation, Tokyo (JP)

(21) Appl. No.: 14/397,899

(22) PCT Filed: Mar. 12, 2013
(86) PCT No.: PCT/JP2013/056805

§ 371 Date: Oct. 30, 2014

(30) Foreign Application Priority Data
Aug. 5, 2012 (JP) 2012-106723

(51) Int. Cl. H04L 29/08; H04L 29/06

(52) U.S. Cl. CPC H04L 67/14; H04L 65/1006
USPC 709/228

(57) ABSTRACT

According to the present disclosure, there is provided an information processing apparatus including a connection control unit configured to generate or update a connection table on the basis of status of communication performed by a communication unit at a time of an operation to establish a session or status of communication regularly performed by the communication unit after the operation to establish the session.

### TECHNICAL FIELD

The present disclosure relates to an information processing apparatus, an information processing method, and a program.

### BACKGROUND ART

In recent years, various technologies related to video distribution have been disclosed (see, for example, Patent Literature 1 below). For example, in the technology disclosed in Patent Literature 1, a relay server for relaying video which is transmitted from a video distribution server is arranged. Like such a technology, it is possible to distribute load put on the video distribution by causing the relay server to relay video.

### CITATION LIST

### Patent Literature

Patent Literature 1: JP 2003-61060A

### SUMMARY OF INVENTION

### Technical Problem

However, in the technology disclosed by Patent Literature 1, a destination to which a device constituting a video distribution network is connected is fixed and connection destinations cannot be dynamically switched depending on status. Therefore, it is desirable to implement a technology for dynamically switching connection destinations depending on status.

### Solution to Problem

According to the present disclosure, there is provided an information processing apparatus including a connection control unit configured to generate or update a connection table on the basis of status of communication performed by a communication unit at a time of an operation to establish a session or status of communication regularly performed by the communication unit after the operation to establish the session.

According to the present disclosure, there is provided an information processing method including generating or updating a connection table on the basis of status of communication performed by a communication unit at a time of an operation to establish a session or status of communication regularly performed by the communication unit after the operation to establish the session.

According to the present disclosure, there is provided a program for causing a computer to function as an information processing apparatus including a connection control unit configured to generate or update a connection table on the basis of status of communication performed by a communication unit at a time of an operation to establish a session or status of communication regularly performed by the communication unit after the operation to establish the session.

### Advantageous Effects of Invention

As described above, according to the present disclosure, a technology for dynamically switching connection destinations depending on status can be provided.

### BRIEF DESCRIPTION OF DRAWINGS

FIG. 1 is an illustration showing a configuration example of an information processing system according to an embodiment of the present disclosure.

FIG. 2 is an illustration showing a functional configuration example of a receiver according to an embodiment of the present disclosure.

FIG. 3 is an illustration showing a functional configuration example of a booster according to an embodiment of the present disclosure.

FIG. 4 is an illustration showing a functional configuration example of a sender according to an embodiment of the present disclosure.

FIG. 5 is an illustration showing a functional configuration example of a booster manager according to an embodiment of the present disclosure.

FIG. 6 is an illustration showing an example of content transfer to be performed during an operation to establish a session.

FIG. 7 is an illustration showing other example of content transfer to be performed during an operation to establish a session.

FIG. 8 is an illustration showing an example of connection table updating when an operation to establish a session fails.

FIG. 9 is an illustration showing an example of connection table updating when receipt of content fails.

FIG. 10 is an illustration showing an example of connection table updating to be performed when a condition is checked.

FIG. 11 is an illustration showing a new connection path to be registered when a failure occurs.

FIG. 12 is an illustration showing an example of connection table updating to be performed when a failure occurs.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

In addition, in this specification and drawings, a plurality of elements that have substantially the same function and structure may be distinguished by different alphabet letters suffixed to same signs. However, if there is no need, in particular, to distinguish each of the plurality of elements that have substantially the same function and structure, only the same sign is assigned.

In addition, the “Description of Embodiments” will be described in the order of the items listed below.

1. Embodiments

1-1. Configuration example of an information processing system

1-2. Functional configuration example of a receiver

1-3. Functional configuration example of a booster

1-4. Functional configuration example of a sender

1-5. Functional configuration example of a booster manager

1-6. Content transfer to be performed during an operation to establish a session

1-7. Connection table updating when an operation to establish a session fails

1-8. Connection table updating when receipt of content fails

1-9. Connection table updating to be performed when a condition is checked

1-10. Connection table updating to be performed when a failure occurs

2. Conclusion

### 1. Embodiments

Embodiments of the present disclosure will be sequentially described in detail.

### 1-1. Configuration Example of an Information Processing System

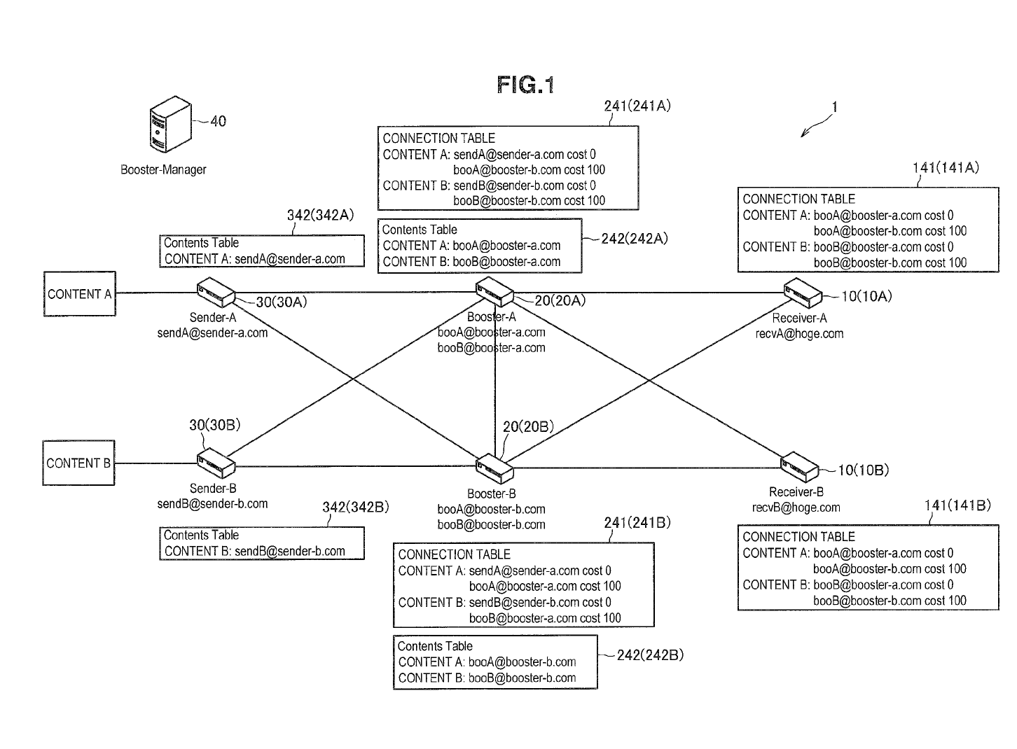

First, a configuration example of an information processing system 1 according to an embodiment of the present disclosure will be described. FIG. 1 is an illustration showing a configuration example of the information processing system 1 according to the embodiment of the present disclosure.

As shown in FIG. 1, the information processing system 1 according to the embodiment of the present disclosure includes a receiver 10A, a receiver 10B, a booster 20A, a booster 20B, a sender 30A, a sender 30B, and a booster manager 40, by way of example. Each of these devices constitutes a network, and is capable of mutual communications using a session initiation protocol (SIP). However, a scheme of communications to be performed by each of these devices is not limited to the SIP.

In FIG. 1, while the two receivers 10 (the receiver 10A and the receiver 10B) constitute the network, the number of the receivers 10 is not specifically limited. In addition, in FIG. 1, while the two boosters 20 (the booster 20A and the booster 20B) constitute the network, the number of the boosters 20 is not specifically limited. In addition, in FIG. 1, while the two senders 30 (the sender 30A and the sender 30B) constitute the network, the number of senders 30 is not specifically limited.

The receiver 10 has a function to receive content. While a type of content is not specifically limited, it may be video content. As shown in FIG. 1, the receiver 10 has a connection table 141 linking content with one or more destinations. In the following, while a case in which an SIP-URI (uniform resource identifier) is used as a destination example will be mainly described, a destination is not limited to the SIP-URI. For a destination of the connection table 141, an adjacent high-order device (the booster 20, the sender 30 and the like) is registered. In the following, an adjacent high-order device is also referred to as an adjacent uplink.

In addition, as shown in FIG. 1, as an example of priority, a cost value is linked with each destination of the connection table 141, and a destination linked with higher priority is preferentially selected. A cost value may be varied within a range notified by the booster manager 40. In the following, while a case in which a cost value is used as priority and a destination linked with a smaller cost value is preferentially selected is described, the priority is not limited to such a cost value. The receiver 10 can establish connections by utilizing the connection table 141 and receive content from a connection destination.

For example, the receiver 10 may directly connect to the sender 30. In such a case, the receiver 10 can receive content from the sender 30 which is a connection destination. In addition, for example, the receiver 10 may directly connect to the booster 20. In such a case, the receiver 10 can receive content which is transmitted by the sender 30 and transferred by the booster 20 which is a connection destination. Note that the receiver 10 functions as an example of an information processing apparatus.

The booster 20 has a function to transfer content. As shown in FIG. 1, the sender 30 has a connection table 241 linking content with one or more destinations. While a case in which the SIP-URI is also used as a destination of the connection table 241 is mainly described, the destination is not limited to the SIP-URI. For a destination of the connection table 241, an adjacent high-order device (other booster 20, the sender 30 and the like) is registered.

In addition, as shown in FIG. 1, as an example of priority, a cost value is linked with each destination of the connection table 241, and a destination linked with higher priority is preferentially selected. In the following, as with the priority of the connection table 141, while a case in which a cost value is also used as priority of the connection table 241 and a destination linked with a smaller cost value is preferentially selected is described, the priority is not limited to such a cost value. The booster 20 can establish connections by utilizing the connection table 241 and receive content from a connection destination.

For example, the booster 20 may directly connect to the sender 30. In such a case, the booster 20 can receive content from the sender 30 which is a connection destination. In addition, for example, the booster 20 may directly connect to other booster 20. In such a case, the booster 20 can receive content which is transmitted by the sender 30 and relayed by the booster 20 which is a connection destination. Note that the booster 20 functions as an example of an information processing apparatus.

Besides, as shown in FIG. 1, the booster 20 has a contents table 242 linking content with destinations. While a case in which the SIP-URI is also used as a destination of the contents table 242 is mainly described, the destination is not limited to the SIP-URI. For a destination of the contents table 242, an adjacent low-order device (the receiver 10, the booster 20 and the like) is registered. When transmitting a connection request to an adjacent high-order device on the basis of other connection request received from the adjacent low-order device, the booster 20 selects content to be acquired on the basis of the contents table 242. For example, the booster 20 selects content linked with a destination of the other connection request, as the content to be acquired.

The sender 30 has a function to transmit content. As shown in FIG. 1, the sender 30 has a contents table 342 linking content with a destination. While a case in which the SIP-URI is also used as a destination of the contents table 342 is described, the destination is not limited to the SIP-URI. For a destination of the contents table 342, an adjacent low-order device (the receiver 10, the booster 20 and the like) is registered. When transmitting content on the basis of a connection request received from the adjacent low-order device, the sender 30 selects content to be acquired on the basis of the contents table 342.

For example, the sender 30 selects content linked with a destination of the connection request as the content to be acquired. The sender 30 transmits the selected content to be acquired to a transmission source of the connection request. In the example shown in FIG. 1, the sender 30A transmits content A and the sender 30B transmits content B. The senders 30 may have content, or any device external to the senders 30 may have content and transmission of the content which the external device has may be controlled by the senders 30.

The booster manager 40 has a function to dynamically update the connection table 241 which the boosters 20 has, the connection table 141 which the receiver 10 has, and the like. The booster manager 40 may be integrated with any of the receiver 10, the booster 20 and the sender 30, or configured separately from the receiver 10, the booster 20 and the sender 30.

Here, a technology for distributing load put on content transmission is present. However, when connection destinations of devices which constitute a network are fixed, status of the content transmission may also vary depending on status of the connection destinations. Therefore, in this embodiment, a technology for dynamically switching connection destinations depending on status is proposed.

So far the configuration example of the information processing system 1 according to the embodiment of the present disclosure has been described. In the following, a functional configuration example of a receiver 10 according to an embodiment of the present disclosure will be described.

### 1-2. Functional Configuration Example of a Receiver

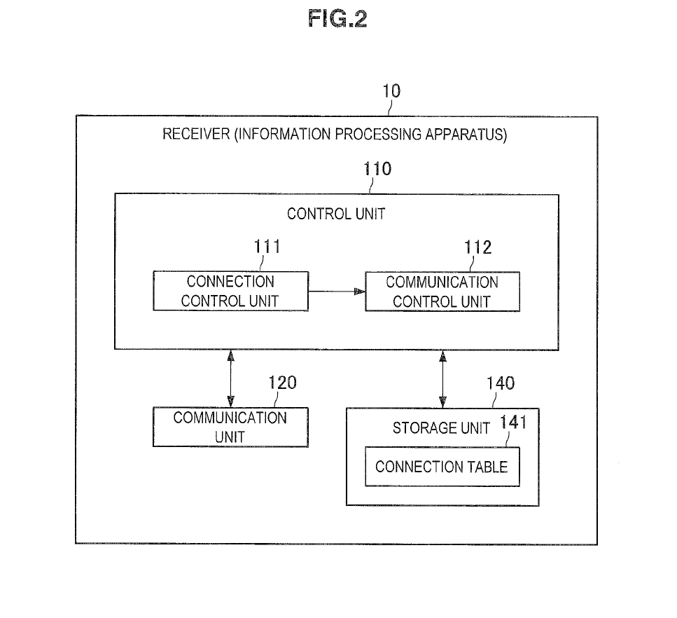

FIG. 2 is an illustration showing a functional configuration example of a receiver 10 according to an embodiment of the present disclosure. As shown in FIG. 2, the receiver 10 includes a control unit 110, a communication unit 120, and a storage unit 140.

The control unit 110 corresponds to a processor such as a central processing unit (CPU) and the like, for example. The control unit 110 performs various functions which the control unit 110 has, by executing a program stored in the storage unit 140 or other storage medium. In addition, the control unit 110 includes a connection control unit 111 and a communication control unit 112.

The connection control unit 111 generates or updates a connection table 141 on the basis of status of communications performed by the communication unit 120 during an operation to establish a session. In addition, the connection control unit 111 generates or updates the connection table 141 on the basis of status of communications regularly performed by the communication unit 120 after the operation to establish a session.

The communication control unit 112 controls communications by the communication unit 120. The communication control unit 112 controls the communication unit 120 so that communications are performed with, for example, a destination selected from the connection table 141.

The communication unit 120 is, for example, a communication interface including a communication device and the like for performing communications with an adjacent device by wireline or wirelessly. An adjacent device includes an adjacent high-order device. As described above, the communication unit 120 performs communications using a SIP, for example.

The storage unit 140 uses a storage medium such as a semiconductor memory or a hard disk and the like to store a program for operating the control unit 110. In addition, for example, the storage unit 140 can store various types of data (the connection table 141 and the like, for example) to be used by the program. In the example shown in FIG. 2, while the storage unit 140 is incorporated in the receiver 10, the storage unit 140 may be present outside the receiver 10.

So far the functional configuration example of the receiver 10 according to the embodiment of the present disclosure has been described. In the following, a functional configuration example of a booster 20 according to an embodiment of the present disclosure will be described.

### 1-3. Functional Configuration Example of a Booster

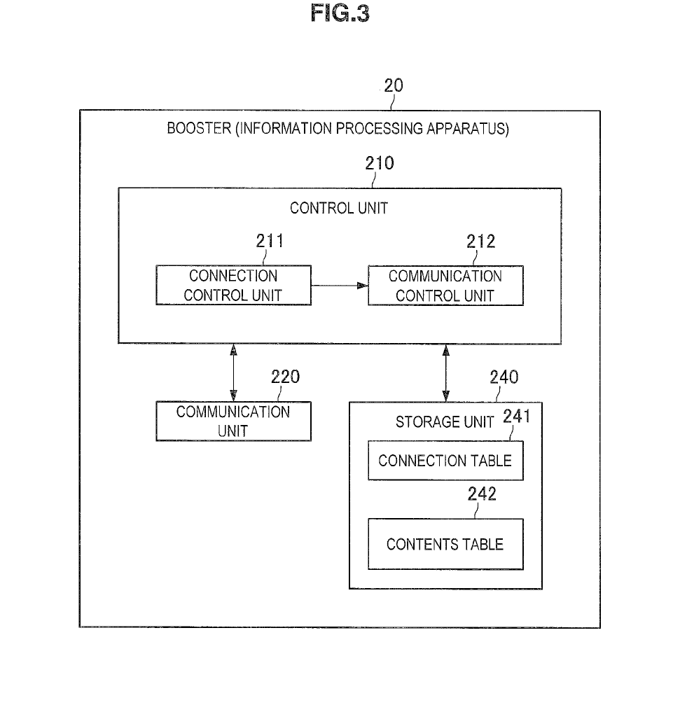

FIG. 3 is an illustration showing a functional configuration example of a booster 20 according to an embodiment of the present disclosure. As shown in FIG. 3, the booster 20 includes a control unit 210, a communication unit 220, and a storage unit 240.

The control unit 210 corresponds to a processor such as a CPU, for example. The control unit 210 performs various functions which the control unit 210 has, by executing a program stored in the storage unit 240 or other storage medium. In addition, the control unit 210 includes a connection control unit 211 and a communication control unit 212.

The connection control unit 211 generates or updates a connection table 241 on the basis of status of communications performed by the communication unit 220 during an operation to establish a session. In addition, the connection control unit 211 generates or updates the connection table 241 on the basis of status of communications regularly performed by the communication unit 220 after the operation to establish a session.

The communication control unit 212 controls communications by the communication unit 220. The communication control unit 212 controls the communication unit 220 so that communications are performed with, for example, a destination selected from the connection table 241.

The communication unit 220 is, for example, a communication interface including a communication device and the like for performing communications with an adjacent device by wireline or wirelessly. An adjacent device includes an adjacent high-order device and an adjacent low-order device. As described above, the communication unit 220 performs communications using a SIP, for example.

The storage unit 240 uses a storage medium such as a semiconductor memory or a hard disk and the like to store a program for operating the control unit 210. In addition, for example, the storage unit 240 can store various types of data (the connection table 241, a contents table 242 and the like, for example) to be used by the program. In the example shown in FIG. 3, while the storage unit 240 is incorporated in the booster 20, the storage unit 140 may be present outside the booster 20.

So far the functional configuration example of the booster 20 according to the embodiment of the present disclosure has been described. In the following, a functional configuration example of a sender 30 according to an embodiment of the present disclosure will be described.

### 1-4. Functional Configuration Example of a Sender

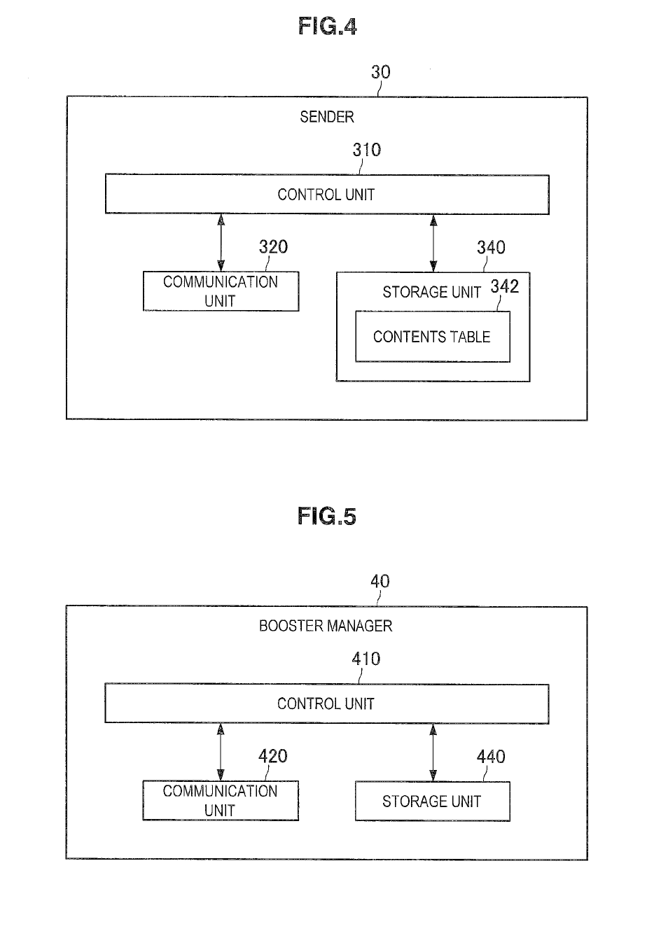

FIG. 4 is an illustration showing a functional configuration example of a sender 30 according to an embodiment of the present disclosure. As shown in FIG. 4, the sender 30 includes a control unit 310, a communication unit 320, and a storage unit 340.

The control unit 310 corresponds to a processor such as a CPU and the like, for example. The control unit 310 performs various functions which the control unit 310 has, by executing a program stored in the storage unit 240 or other storage medium.

The communication unit 320 is, for example, a communication interface including a communication device and the like for performing communications with an adjacent device by wireline or wirelessly. An adjacent device includes an adjacent low-order device. As described above, the communication unit 320 performs communications using a SIP, for example.

The storage unit 340 uses a storage medium such as a semiconductor memory or a hard disk and the like to store a program for operating the control unit 210. In addition, for example, the storage unit 340 can store various types of data (a contents table 342 and the like, for example) to be used by the program. In the example shown in FIG. 4, while the storage unit 340 is incorporated in the sender 30, the storage unit 340 may be present outside the sender 30.

So far the functional configuration example of the sender 30 according to the embodiment of the present disclosure has been described. In the following, a functional configuration example of a booster manager 40 according to an embodiment of the present disclosure will be described.

### 1-5. Functional Configuration Example of a Booster Manager

FIG. 5 is an illustration showing a functional configuration example of a booster manager 40 according to an embodiment of the present disclosure. As shown in FIG. 5, the booster manager 40 includes a control unit 410, a communication unit 420, and a storage unit 440.

The control unit 410 corresponds to a processor such as a CPU, for example. The control unit 410 performs various functions which the control unit 410 has, by executing a program stored in the storage unit 440 or other storage medium.

The communication unit 420 is, for example, a communication interface including a communication device and the like for performing communications with various devices (a receiver 10, a booster 20, a sender 30 and the like, for example) by wireline or wirelessly. As described above, the communication unit 420 performs communications using a SIP, for example.

The storage device 440 uses a storage medium such as a semiconductor memory or a hard disk and the like to store a program for operating the control unit 410. In addition, for example, the storage unit 440 can store various types of data (a connection table of each device, for example) to be used by the program. In the example shown in FIG. 5, while the storage unit 440 is incorporated in the booster manager 40, the storage unit 440 may be present outside the booster manager 40.

So far the functional configuration example of the booster manager 40 according to the embodiment of the present disclosure has been described. In the following, details of an information processing system 1 according to an embodiment of the present disclosure will be described. First, examples of content transfer to be performed during an operation to establish a session will be described.

### 1-6. Content Transfer to be Performed During an Operation to Establish a Session

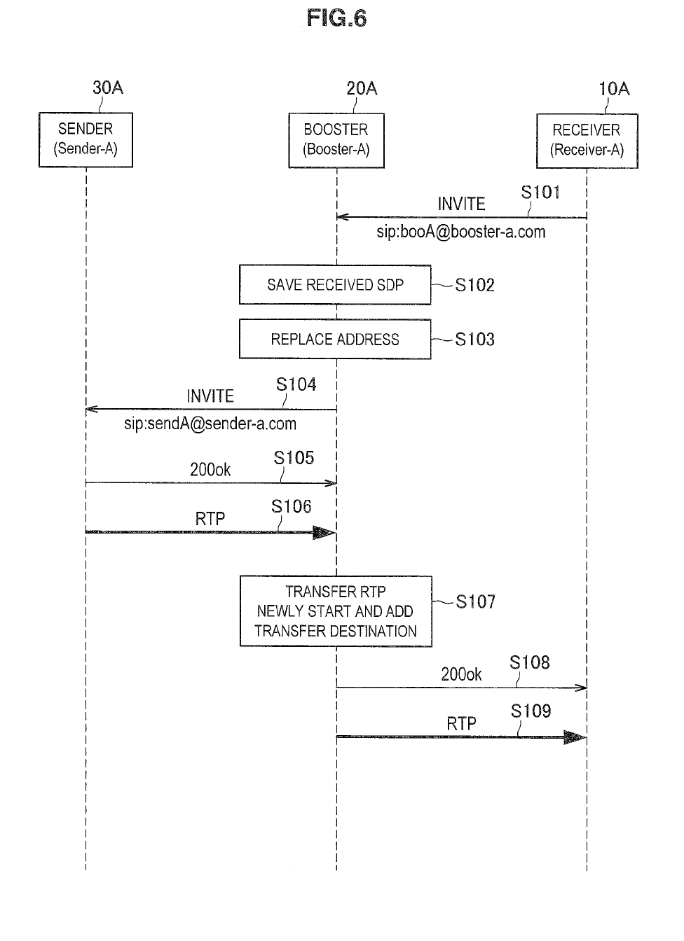

FIG. 6 is an illustration showing an example of content transfer to be performed during an operation to establish the session. In the example shown in FIG. 6, a case is assumed in which content to be acquired is content A. First, based on a connection table 141A, a communication control unit 112 of a receiver 10A controls a communication unit 120 so that a connection request is transmitted to any of one or more destinations linked with the content to be acquired. The communication control unit 112 of the receiver 10A selects a destination of the connection request on the basis of a cost value, for example. In FIG. 6, a case is shown in which among destinations linked with the content A, the communication control unit 112 of the receiver 10A selects a destination “booA@booster-a.com” having the lowest cost value. The communication unit 120 of the receiver 10A transmits the connection request to this destination (S101). In the example shown in FIG. 6, the connection request is made by an INVITE message.

When a communication unit 220 of a booster 20A receives the connection request, first, a communication control unit 212 of the booster 20A selects content to be acquired on the basis of a contents table 242A. FIG. 6 shows a case in which the communication control unit 112 of the booster 20A selects the content A linked with “booA@booster-a.com”.

Then, based on the connection table 241A, the communication control unit 212 of the booster 20A controls the communication unit 220 so that a connection request is transmitted to any of one or more destinations linked with the content to be acquired. The communication control unit 212 of the booster 20A selects a destination of the connection request on the basis of a cost value, for example. FIG. 6 shows a case in which the communication control unit 212 of the booster 20A selects a destination “sendA@sender-a.com” having the lowest cost value among the destinations linked with the content A.

Here, for example, the communication control unit 212 of the booster 20A saves a session description protocol (SDP) received by the communication unit 220 (S102), and sets a destination of the connection request by replacing an address of the SDP (S103). The communication unit 220 of the booster 20A transmits the connection request to this destination (S104). In the example shown in FIG. 6, the connection request is made by the INVITE message. The communication control unit 212 of the booster 20A may control so that the connection request is transmitted when the content A has not yet been received.

When receiving the connection request, a communication unit 320 of a sender 30A transmits content to the booster 20A on the basis of the connection request. First, a control unit 310 of the sender 30A selects content to be acquired on the basis of a contents table 342A. FIG. 6 shows a case in which the control unit 310 of the sender 30A selects the content A linked with “sendA@sender-a.com”.

When normally processing the connection request, the communication unit 320 of the sender 30A transmits a response, which indicates accordingly, to the booster 20A (S105). The response which indicates that the connection request has been normally processed is made by a 200ok message in the example shown in FIG. 6. The control unit 310 of the sender 30A acquires the content A to be acquired, and the communication unit 320 of the sender 30A transmits the acquired content A to the booster 20A (S106). The content transmission is performed by a real-time transport protocol (RTP) in the example shown in FIG. 6.

The communication unit 220 of the booster 20A receives the content A from the sender 30A. The communication control unit 212 of the booster 20A newly starts an RTP to add the receiver 10A to a transfer destination of the RTP (S107). When normally processing the connection request, the communication unit 220 of the booster 20A transmits a response, which indicates accordingly, to the receiver 10A (S108). The response which indicates that the connection request has been normally processed is made by the 200ok message in the example shown in FIG. 6. The communication control unit 212 of the booster 20A controls the communication unit 220 so that the content A is transferred to the receiver 10A, and the communication unit 220 of the booster 20A transfers the content A to the receiver 10A (S109). In the example shown in FIG. 6, the content transfer is performed by RTP transfer in the example shown in FIG. 6.

So far the example of content transfer to be performed during an operation to establish a session has been described. In the following, other example of content transfer to be performed during an operation to establish a session will be described.

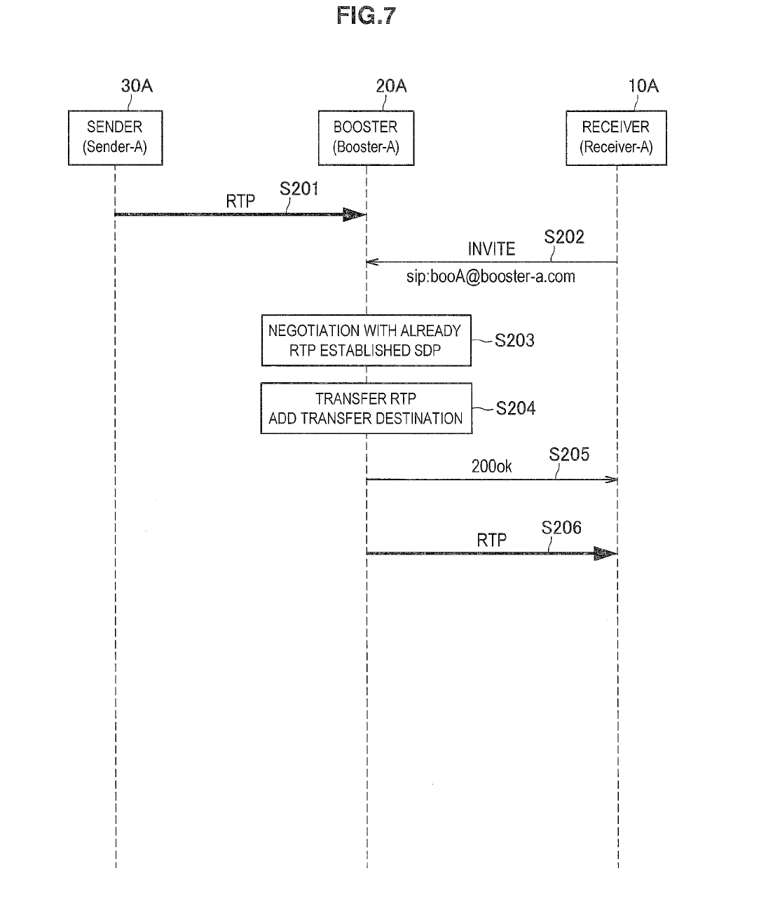

FIG. 7 is an illustration showing other example of content transfer to be performed during an operation to establish a session. In the example shown in FIG. 7, a case is assumed in which content to be acquired has already been received from the sender 30A. That is to say, as shown in FIG. 7, the control unit 310 of the sender 30A acquires the content A which is to be acquired, and the communication unit 320 of the sender 30A has already transmitted the acquired content A to the booster 20A (S201).

In such status, as with the case shown in FIG. 6, the communication unit 120 of the receiver 10A transmits a connection request (S202). When the communication unit 220 of the booster 20A receives the connection request, first, the communication control unit 212 of the booster 20A selects content to be acquired on the basis of the contents table 242A. FIG. 6 shows a case in which the communication control unit 112 of the booster 20A selects the content A linked with “booA@booster-a.com”.

Then, when the communication unit 220 has already received the content A from the sender 30A, the communication control unit 212 of the booster 20A controls the communication unit 220 so that the already received content A is transferred to the receiver 10A. In the example shown in FIG. 7, the communication control unit 212 of the booster 20A performs negotiations (S203) with the SDP which has already been RTP established, and adds the receiver 10A to a transfer destination of the RTP (S204).

When normally processing the connection request, the communication unit 220 of the booster 20A transmits a response, which indicates accordingly, to the receiver 10A (S205). The communication unit 220 of the booster 20A transfers the content A to the receiver 10A according to the control by the communication control unit 212 (S206). As such, if the content has already been received, transferring the content enables reduction of an amount of communications between the booster 20A and the sender 30A.

So far the example of content transfer to be performed during an operation to establish a session has been described. In the following, examples of dynamically updating a connection table depending on status will be sequentially described. First, an example of connection table updating when an operation to establish a session fails will be described.

### 1-7. Connection Table Updating when an Operation to Establish a Session Fails

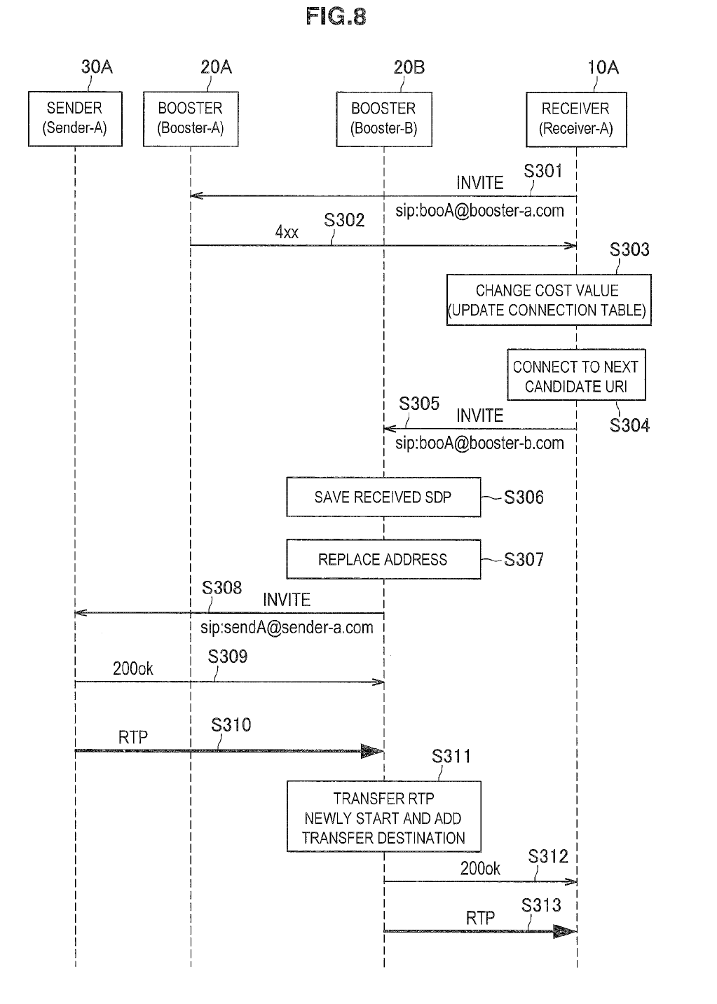

FIG. 8 is an illustration showing an example of connection table updating when an operation to establish a session fails. In the example shown in FIG. 8, a case is assumed in which content to be acquired is content A. First, as with the case shown in FIG. 6, a communication unit 120 of a receiver 10A transmits a connection request (S301).

It is assumed that although the communication unit 220 of the booster 20A starts an operation to establish a session when receiving the connection request, the communication unit 220 fails in the operation to establish a session. In such a case, the communication unit 220 transmits to the receiver 10A a response indicating that the operation to establish a session has failed (S302). The response indicating that the operation to establish a session has failed is made by a 4xx message in the example shown in FIG. 8.

A connection control unit 111 of the receiver 10A updates a connection table 141 if connection status with a destination of the connection request is not normal. In the example shown in FIG. 8, the communication unit 120 of the receiver 10A receives the response indicating that the operation to establish a session has failed, and it is understood that the connection using the connection request has failed. Thus, the connection control unit 111 may update the connection table 141. More specifically, the connection control unit 111 may make a change to increase a cost value linked with a destination of the connection request (S303). The change to increase the cost value makes a cost value linked with other destination relatively lower, thus the other destination being selected.

A communication control unit 112 of the receiver 10A reselects a destination of the connection request on the basis of the connection table after being updated, and controls the communication unit 120 so that the connection request is transmitted to the reselected destination. The communication unit 120 of the receiver 10A makes a connection to a next candidate URI according to the control by the communication control unit 112 (S304). In the example shown in FIG. 8, a destination “booA@booster-b.com” of a booster 20B is selected. In such a case, as with the case shown in FIG. 6, the communication unit 120 of the receiver 10A transmits the connection request to this destination (S305).

When the communication unit 220 of the booster 20B receives the connection request, first, the communication control unit 212 of the booster 20B selects content to be acquired on the basis of a contents table 242B. FIG. 8 shows a case in which the communication control unit 112 of the booster 20A selects the content A linked with “booA@booster-b.com”.

Then, based on a connection table 241B, the communication control unit 212 of the booster 20B controls the communication unit 220 so that the connection request is transmitted to any of one or more destinations linked with the content to be acquired. The communication control unit 212 of the booster 20B selects a destination of the connection request on the basis of a cost value, for example. FIG. 8 shows a case in which the communication control unit 212 of the booster 20B selects a destination “sendA@sender-a.com” having the lowest cost value among destinations linked with the content A.

Here, for example, the communication control unit 212 of the booster 20B saves an SDP received by the communication unit 220 (S306), and sets a destination of the connection request by replacing an address of the SDP (S307). The communication unit 220 of the booster 20B transmits the connection request to this destination (S308). In the example shown in FIG. 8, the connection request is made by an INVITE message. The communication control unit 212 of the booster 20B may control so that the connection request is transmitted if the content A has not yet been received.

When receiving the connection request, a communication unit 320 of a sender 30A transmits content to the booster 20B on the basis of the connection request. First, a control unit 310 of the sender 30A selects content to be acquired on the basis of a contents table 342A. FIG. 8 shows a case in which the control unit 310 of the sender 30A selects the content A linked with “sendA@sender-a.com”.

When normally processing the connection request, the communication unit 320 of the sender 30A transmits a response, which indicates accordingly, to the booster 20A (S309). The response indicating the connection request has been normally processed is made by a 200ok message in the example shown in FIG. 8. The control unit 310 of the sender 30A acquires the content A to be acquired, and the communication unit 320 of the sender 30A transmits the acquired content A to the booster 20B (S310). In the example shown in FIG. 8, transmission of the content is performed by an RTP.

The communication unit 220 of the booster 20B receives the content A from the sender 30A. The communication control unit 212 of the booster 20B newly starts an RTP, and adds the receiver 10A to a transfer destination of the RTP (S311). When normally processing the connection request, the communication unit 220 of the booster 20B transmits a response, which indicates accordingly, to the receiver 10A (S312). The response indicating that the connection request has been normally processed is made by the 200ok message in the example shown in FIG. 8. The communication control unit 212 of the booster 20B controls the communication unit 220 so that the content A is transferred to the receiver 10A, and the communication unit 220 of the booster 20B transfers the content A to the receiver 10A (S313). In the example shown in FIG. 8, the content transfer is performed by RTP transfer.

Note that the example shown in FIG. 8 illustrates a case in which the content A has not yet been received by the booster 20B. However, a case is also assumed in which the content A has already been received by the booster 20B. In such a case, as shown in FIG. 7, the already received content A may also be transferred to the receiver 10A. In addition, in the example shown in FIG. 7, while connection table updating when the operation to establish a session fails is performed in the receiver 10, the connection table updating may be performed in the booster 20.

So far the example of connection table updating when the operation to establish a session fails has been described. In the following, an example of connection table updating when receipt of content fails will be described.

### 1-8. Connection Table Updating when Receipt of Content Fails

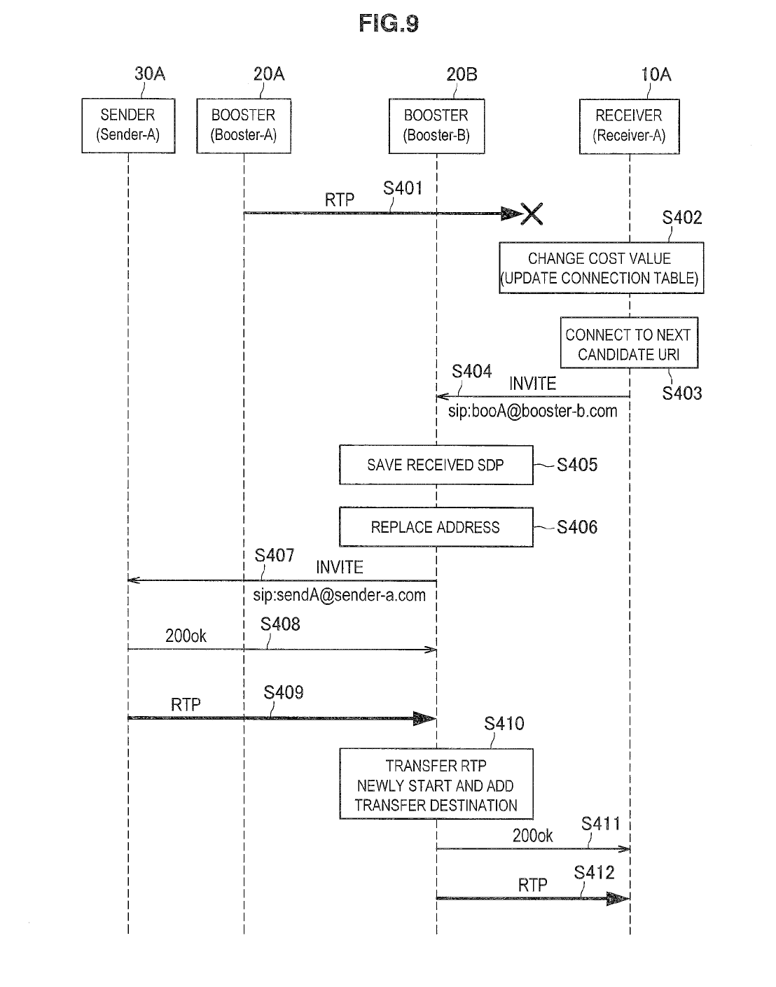

FIG. 9 is an illustration showing an example of connection table updating when receipt of content fails. In the example shown in FIG. 8, a case is assumed in which content to be acquired is content A. In addition, as with the case shown in FIG. 8, it is also assumed that a communication unit 120 of a receiver 10A transmits a connection request to a booster 20A and, as a result of successful connection, receives the content A from the booster 20A.

Here, when receipt of the content A from the booster 20A fails (S401), a connection control unit 111 of the receiver 10A may update a connection table 141. More specifically, the connection control unit 11 may make a change to increase a cost value linked with a destination of the connection request (S402). The change to increase the cost value makes a cost value linked with other destination relatively lower, thus the other destination being selected.

A communication control unit 112 of the receiver 10A reselects a destination of the connection request on the basis of the connection table after being updated, and controls the communication unit 120 so that the connection request is transmitted to the reselected destination. The communication unit 120 of the receiver 10A makes a connection to a next candidate URI according to the control by the communication control unit 112 (S403). In the example shown in FIG. 8, a destination “booA@booster-b.com” of a booster 20B is selected. In such a case, as with the case shown in FIG. 7, the communication unit 120 of the receiver 10A transmits the connection request to this destination (S404).

A communication unit 220 of the booster 20B receives the connection request. Since subsequent steps (S407 to S412) can be performed similar to the steps (S303 to S313) as shown in FIG. 8, a description is omitted. Note that if the content A has already been received by the booster 20B, as shown in FIG. 7, the already received content A may also be transferred to the receiver 10A. In addition, in the example shown in FIG. 8, while connection table updating when receipt of content fails is performed in the receiver 10, the connection table updating may be performed in the booster 20.

So far the example of connection table updating when receipt of content fails has been described. In the following, an example of connection table updating to be performed when a condition is checked after an operation to establish a session is done will be described.

### 1-9. Connection Table Updating to be Performed when a Condition is Checked

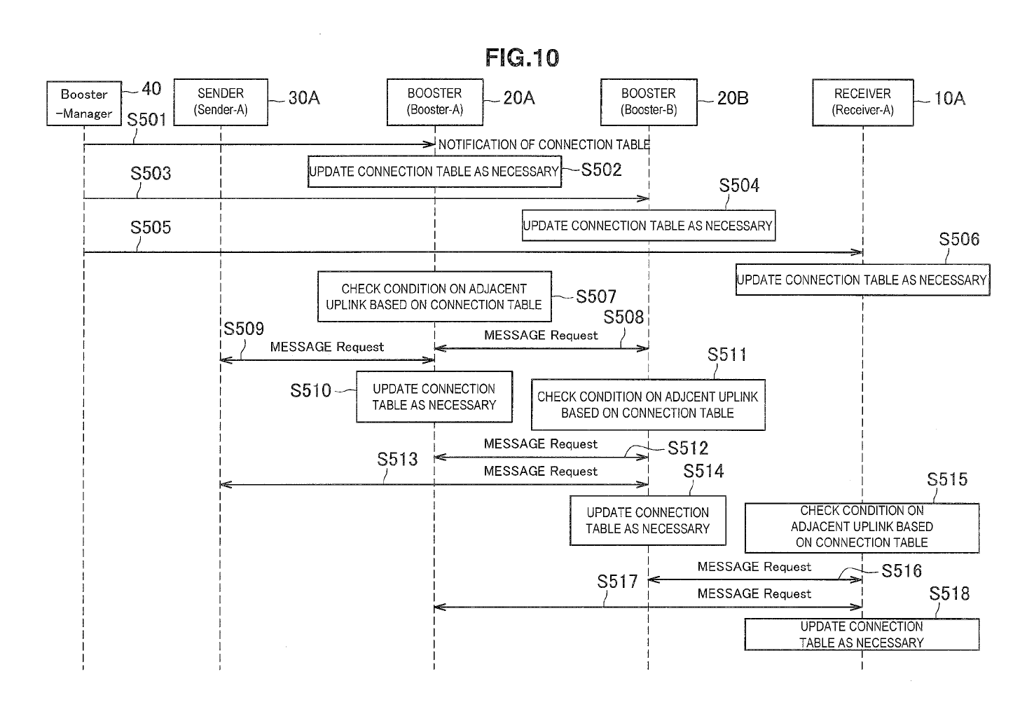

FIG. 10 is an illustration showing an example of connection table updating to be performed when a condition is checked. In the example shown in FIG. 10, a case is assumed in which a condition is regularly checked after an operation to establish a session is performed. First, a control unit 410 of a booster manager 40 notifies a booster 20A of a connection table via a communication unit 420 (S501). In response to the notification of the connection table, a communication unit 220 of the booster 20A updates a connection table 241 as necessary (S502).

Similarly, the control unit 410 of the booster manager 40 notifies a booster 20B of the connection table via the communication unit 420 (S503). The communication unit 220 of the booster 20B receives the notification of the connection table, and the connection control unit 211 of the booster 20B updates the connection table 241 as necessary (S504). Similarly, the control unit 410 of the booster manager 40 notifies a receiver 10A of the connection table via the communication unit 420 (S505). A communication unit 120 of the receiver 10A receives the notification of the connection table, and a connection control unit 111 of the receiver 10A updates a connection table 141 as necessary (S506).

Then, a communication control unit 212 of the booster 20A regularly performs condition check on an adjacent uplink, on the basis of the connection table 241A (S507). Here, the condition check on the adjacent uplink is performed on a sender 30A and the booster 20B by “MESSAGE Request” which is an example of a condition check message to be regularly transmitted (S508, S509). An adjacent uplink corresponds to a destination to be selected from a connection table 241A, for example. As such, the communication control unit 212 of the booster 20A controls the communication unit 220 so that a condition check message is regularly transmitted to a destination selected from the connection table 241A.

Here, the connection control unit 211 of the booster 20A may update the connection table 241A as necessary (S510). For example, the connection control unit 211 of the booster 20A may update the connection table 241A if the condition of a destination of the condition check message is not normal. More specifically, if it is confirmed that the condition of the destination of the condition check message is not normal, the connection control unit 211 of the booster 20A may make a change to increase a cost value linked with the destination which is registered in the connection table 241A. The change to increase the cost value makes a cost value linked with other destination relatively lower, thus the other destination being selected.

In addition, for example, the connection control unit 211 of the booster 20A may update the connection table 241A if the condition of the destination of the condition check message is normal. More specifically, if it is confirmed that the condition of the destination of the condition check message is normal, the connection control unit 211 of the booster 20A may make a change to reduce a cost value linked with the destination which is registered in the connection table 241A. With the change to reduce the cost value, the destination is selected.

Since subsequent steps (S511 to S514) can be performed similar to the steps (S507 to S510), a description is omitted. In addition, since steps (S515 to S518) can also be performed similar to the steps (S507 to S510), a description is omitted.

So far the example of connection table updating when a condition is checked after an operation to establish a session has been described. In the following, examples of connection table updating to be performed when a failure occurs will be described.

### 1-10. Connection Table Updating to be Performed when a Failure Occurs

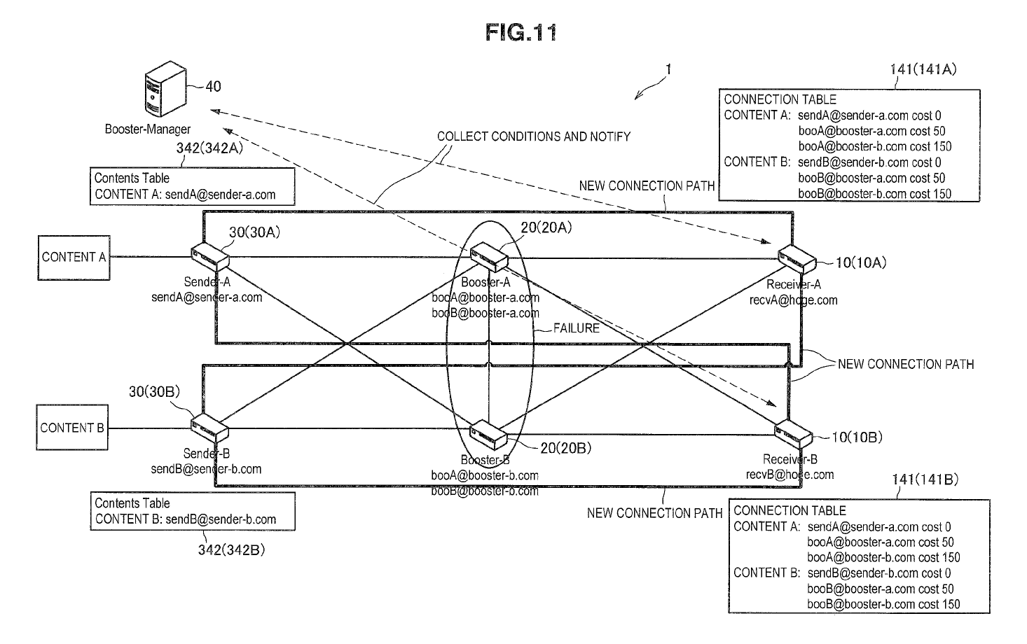

FIG. 11 is an illustration showing a new connection path to be registered when a failure occurs. In the example shown in FIG. 11, a case is assumed in which a failure occurs in a booster 20A and a booster 20B. First, a control unit 410 of a booster manager 40 collects conditions of the booster 20A and the booster 20B. The control unit 410 of the booster manager 40 regenerates a connection table 141A and a connection table 141B, depending on the conditions of the booster 20A and the booster 20B.

In the example shown in FIG. 11, as a new connection path, paths from a receiver 10A to a sender 30A and a sender 30B and paths from a receiver 10B to the sender 30A and the sender 30B are generated. The regenerated connection table 141A is notified by the control unit 410 of the booster manager 40 to the receiver 10A, and the regenerated connection table 141B is notified by the control unit 410 of the booster manager 40 to the receiver 10B.

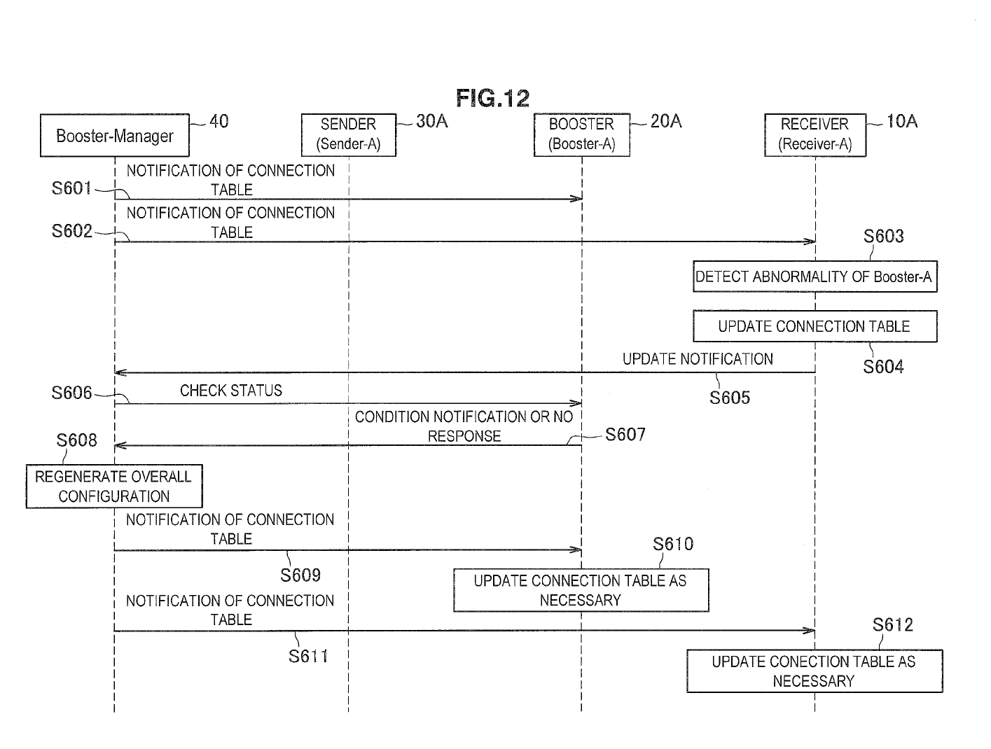

FIG. 12 is an illustration showing an example of connection table updating to be performed when a failure occurs. In the example shown in FIG. 12, a case is assumed in which a failure occurs in the booster 20A. First, a communication unit 420 of the booster manager 40 notifies a connection table of the booster 20A to the booster 20A (S601), and the connection table of the receiver 10A to the receiver 10A (S602). A connection control unit 211 of the booster 20A updates a connection table 241A with the notified connection table, and a connection control unit 111 of the receiver 10A updates a connection table 141a with the notified connection table.

When abnormality of the booster 20A is detected (S603), a communication control unit 112 of the receiver 10A updates the connection table 141A (S604). For example, the communication control unit 112 of the receiver 10A performs updating to increase a cost value linked with a destination of the booster 20 where the abnormality is detected, among destinations registered in the connection table 141A. The communication control unit 112 of the receiver 10A performs updating notification to the booster manager 40 (S605) that the cost value linked with the destination of the booster 20A has been updated.

When receiving the update notification, a control unit 110 of the booster manager 40 checks status of the booster 20A (S606). As a result of the status check, it is assumed that the control unit 110 of the booster manager 40 receives a condition notification informing abnormal conditions from the booster 20A or it is assumed that no special response is sent back from the booster 20A. In such a case, the control unit 410 of the booster manager 40 regenerates an overall configuration of a connection table of each device.

The control unit 410 of the booster manager 40 controls so that the connection table of the booster 20A after being regenerated is transmitted to the booster 20A (S609). The connection control unit 211 of the booster 20A updates the connection table 241A with the notified connection table as necessary (S610). In addition, the control unit 410 of the booster manager 40 controls so that the connection table of the receiver 10A after being regenerated is transmitted to the receiver 10A (S611). The connection control unit 111 of the receiver 10A updates the connection table 141A with the notified connection table as necessary (S612).

So far the examples of connection table updating when a failure occurs have been described.

### 2. Conclusion

As described above, according to the embodiments of the present disclosure, can be provided an information processing apparatus including a connection control unit configured to generate or update a connection table on the basis of status of communications performed by a communication unit during an operation to establish a session or status of communications regularly performed by the communication unit after the operation to establish a session. According to such a configuration, a technology for dynamically switching connection destinations depending on status is provided.

Specifically, each device which constitutes an information processing system is capable of mutual communications using an SIP. An information processing system according to the embodiments of the present disclosure has an exceptional effect that the information processing system can create a video distribution network for distributing video by using the SIP.

Although the preferred embodiments of the present disclosure have been described in detail with reference to the accompanying drawings, a technological scope of the present disclosure is not limited to such examples. It is obvious that a person having the ordinary skill in the art can conceive various kinds of variations or modifications within the scope of the technological idea described in the Claims, and it is understood that the variations or modifications also naturally belong to the technological scope of the present disclosure.

Respective steps in the operations of the information processing system 1 of the specification are not necessarily processed in chronological order which follows the order described as a flow chart. For example, respective steps in the operations of the information processing system 1 may be processed in the order which differs from the order described as a flow chart or may be processed concurrently.

In addition, a computer program can be created that causes hardware such as a CPU, a ROM, and a RAM and the like built in the receiver 10 to perform functions equivalent to the configuration of the above-mentioned receiver 10. In addition, a storage medium in which the computer program is stored is also provided.

Similarly, a computer program can be created that causes hardware such as a CPU, a ROM, and a RAM and the like built in the booster 20 to perform functions equivalent to the configuration of the above-mentioned booster 20. In addition, a storage medium in which the computer program is stored is also provided.

Similarly, a computer program can be created that causes hardware such as a CPU, a ROM, and a RAM and the like built in the sender 30 to perform functions equivalent to the configuration of the above-mentioned sender 30. In addition, a storage medium in which the computer program is stored is also provided.

Similarly, a computer program can be created that causes hardware such as a CPU, a ROM, and a RAM and the like built in the booster manager 40 to perform functions equivalent to the configuration of the above-mentioned booster manager 40. In addition, a storage medium in which the computer program is stored is also provided.

Additionally, the present technology may also be configured as below.

(1)

An information processing apparatus including:

a connection control unit configured to generate or update a connection table on the basis of status of communication performed by a communication unit at a time of an operation to establish a session or status of communication regularly performed by the communication unit after the operation to establish the session.

(2)

The information processing apparatus according to (1), wherein

the communication unit performs communication using a session initiation protocol (SIP).

(3)

The information processing apparatus according to (1) or (2), further including:

a communication control unit configured to control communication by the communication unit,

wherein the communication control unit controls the communication unit so that communication with a destination to be selected from the connection table is performed.

(4)

The information processing apparatus according to any one of (1) to (3), wherein

the connection table is a table linking content with one or more destinations.

(5)

The information processing apparatus according to (4), wherein

the communication control unit controls the communication unit, based on the connection table, so that a connection request is transmitted to any of the one or more destinations linked with the content to be acquired, and

the connection control unit updates the connection table when status of connection with the destination of the connection request is not normal.

(6)

The information processing apparatus according to (5), wherein

the connection control unit updates the connection table when connection using the connection request fails.

(7)

The information processing apparatus according to (5), wherein

the connection control unit updates the connection table when receipt of the content from the destination of the connection request fails.

(8)

The information processing apparatus according to any one of (5) to (7), wherein

the communication control unit reselects a destination of the connection request on the basis of the connection table after being updated, and controls the communication unit so that the connection request is transmitted to the reselected destination.

(9)

The information processing apparatus according to any one of (5) to (8), wherein

priority is linked with each destination of the connection table, and

the communication control unit selects a destination of the connection request on the basis of the priority.

(10)

The information processing apparatus according to (9), wherein

the connection control unit updates priority linked with the destination of the connection request when status of connection with the destination of the connection request is not normal.

(11)

The information processing apparatus according to any one of (5) to (10), wherein

the communication control unit selects the content to be acquired on the basis of a contents table when the connection request is transmitted based on another connection request which is received from another information processing apparatus.

(12)

The information processing apparatus according to (11), wherein

the contents table is a table linking content with a destination.

(13)

The information processing apparatus according to (12), wherein

the communication control unit controls the communication unit so that when the connection using the connection request succeeds and the communication unit receives the content from a connection destination, the content is transferred to the another information processing apparatus.

(14)

The information processing apparatus according to (13), wherein

the communication control unit controls the communication unit so that when the communication unit has already received the content from the destination of the connection request, the already received content is transferred to the another information processing apparatus.

(15)

The information processing apparatus according to (3) or (4), wherein

the communication control unit controls the communication unit so that a condition check message is regularly transmitted to a destination to be selected from the connection table, and

the connection control unit updates the connection table when condition of the destination of the condition check message is not normal.

(16)

An information processing method including:

generating or updating a connection table on the basis of status of communication performed by a communication unit at a time of an operation to establish a session or status of communication regularly performed by the communication unit after the operation to establish the session.

(17)

A program for causing a computer to function as an information processing apparatus including:

a connection control unit configured to generate or update a connection table on the basis of status of communication performed by a communication unit at a time of an operation to establish a session or status of communication regularly performed by the communication unit after the operation to establish the session.

### REFERENCE SIGNS LIST

1 information processing system
10 (10A, 10B) receiver (information processing apparatus)
20 (20A, 20B) booster (information processing apparatus)
30 (30A, 30B) sender
40 booster manager
110 control unit
111 connection control unit
112 communication control unit
120 communication unit
140 storage unit
141 (141A, 141B) connection table
210 control unit
211 connection control unit
212 communication control unit
220 communication unit
240 storage unit
241 (241A, 241B) connection table
242 (242A, 242B) contents table
310 control unit
320 communication unit
340 storage unit
342 (342A, 342B) contents table
410 control unit
420 communication unit
440 storage unit

1. An information processing apparatus comprising:
a connection control unit configured to generate or update a connection table on the basis of status of communication performed by a communication unit at a time of an operation to establish a session or status of communication regularly performed by the communication unit after the operation to establish the session.

2. The information processing apparatus according to claim 1, wherein
the communication unit performs communication using a session initiation protocol (SIP).

3. The information processing apparatus according to claim 1, further comprising:
a communication control unit configured to control communication by the communication unit,
wherein the communication control unit controls the communication unit so that communication with a destination to be selected from the connection table is performed.

4. The information processing apparatus according to claim 1, wherein
the connection table is a table linking content with one or more destinations.

5. The information processing apparatus according to claim 4, wherein
the communication control unit controls the communication unit, based on the connection table, so that a connection request is transmitted to any of the one or more destinations linked with the content to be acquired, and
the connection control unit updates the connection table when status of connection with the destination of the connection request is not normal.

6. The information processing apparatus according to claim 5, wherein
the connection control unit updates the connection table when connection using the connection request fails.

7. The information processing apparatus according to claim 5, wherein
the connection control unit updates the connection table when receipt of the content from the destination of the connection request fails.

8. The information processing apparatus according to claim 5, wherein
the communication control unit reselects a destination of the connection request on the basis of the connection table after being updated, and controls the communication unit so that the connection request is transmitted to the reselected destination.

9. The information processing apparatus according to claim 5, wherein
priority is linked with each destination of the connection table, and
the communication control unit selects a destination of the connection request on the basis of the priority.

10. The information processing apparatus according to claim 9, wherein
the connection control unit updates priority linked with the destination of the connection request when status of connection with the destination of the connection request is not normal.

11. The information processing apparatus according to claim 5, wherein
the communication control unit selects the content to be acquired on the basis of a contents table when the connection request is transmitted based on another connection request which is received from another information processing apparatus.

12. The information processing apparatus according to claim 11, wherein
the contents table is a table linking content with a destination.

13. The information processing apparatus according to claim 12, wherein
the communication control unit controls the communication unit so that when the connection using the connection request succeeds and the communication unit receives the content from a connection destination, the content is transferred to the another information processing apparatus.

14. The information processing apparatus according to claim 13, wherein
the communication control unit controls the communication unit so that when the communication unit has already received the content from the destination of the connection request, the already received content is transferred to the another information processing apparatus.

15. The information processing apparatus according to claim 3, wherein
the communication control unit controls the communication unit so that a condition check message is regularly transmitted to a destination to be selected from the connection table, and
the connection control unit updates the connection table when condition of the destination of the condition check message is not normal.

16. An information processing method comprising:
generating or updating a connection table on the basis of status of communication performed by a communication unit at a time of an operation to establish a session or status of communication regularly performed by the communication unit after the operation to establish the session.

17. A program for causing a computer to function as an information processing apparatus comprising:
a connection control unit configured to generate or update a connection table on the basis of status of communication performed by a communication unit at a time of an operation to establish a session or status of communication regularly performed by the communication unit after the operation to establish the session.
